(19) United States
(12) Patent Application Publication
(10) Pub. No.: US 2023/0119449 A1
(43) Pub. Date: Apr. 20, 2023

(54) TRANSCEIVER AND METHOD FOR CONTROLLING CONFIGURATION OF TRANSCEIVER

(71) Applicant: MEDIATEK INC., Hsin-Chu (TW)

(72) Inventors: Tse-Yu Chen, Hsinchu City (TW); Chun-Wei Lin, Hsinchu City (TW)

(73) Assignee: MEDIATEK INC., Hsin-Chu (TW)

(21) Appl. No.: 17/963,209

(22) Filed: Oct. 11, 2022

Related U.S. Application Data
(60) Provisional application No. 63/257,159, filed on Oct. 19, 2021.

(51) Int. Cl. H04B 1/40

(52) U.S. Cl. CPC H04B 1/40

(57) ABSTRACT

A transceiver and a method for controlling a configuration of the transceiver are provided. The transceiver includes a power amplifier, a receiver and a transformer, wherein the transformer includes a first inductor coupled to the power amplifier, and a second inductor coupled to the receiver. The power amplifier is configured to output transmitted signals when the transceiver operates in a transmitting mode. The receiver is configured to receive a received signal when the transceiver operates in a receiving mode. More particularly, voltage levels of a first end and a second end of the first inductor are pulled to a same voltage level when the transceiver operates in the receiving mode.

### CROSS REFERENCE TO RELATED APPLICATIONS

This application claims the benefit of U.S. Provisional Application No. 63/257,159, filed on Oct. 19, 2021. The content of the application is incorporated herein by reference.

### BACKGROUND

The present invention is related to design of transceivers, and more particularly, to a transceiver and a method for controlling a configuration of the transceiver.

For a transceiver with an architecture featuring a shared port of a transmitter and a receiver, it is typically to compromise performance of one of the transmitter and the receiver in order to optimize performance of the other one. In detail, when the transmitter is disabled, a loading introduced by the disabled transmitter still impacts operations of the receiver; and when the receiver is disabled, a loading introduced by the disabled receiver still impacts operations of the transmitter. Thus, optimization of both the transmitter and the receiver takes a long time for iteratively modifying parameter designs of the transmitter and the receiver.

Thus, there is a need for a novel architecture and a related method, which can optimize the performance of both the transmitter and the receiver without compromising any one of them or less likely to compromise any of them.

### SUMMARY

An objective of the present invention is to provide a transceiver and a method for controlling a configuration of the transceiver, in order to optimize performance of both a transmitter and a receiver within the transceiver without introducing any side effect or in way that is less likely to introduce side effects.

At least one embodiment of the present invention provides a transceiver. The transceiver may comprise a power amplifier, a receiver and a transformer, wherein the transformer may comprise a first inductor coupled to the power amplifier, and a second inductor coupled to the receiver. The power amplifier is configured to output transmitted signals when the transceiver operates in a transmitting mode. The receiver is configured to receive a received signal when the transceiver operates in a receiving mode. More particularly, voltage levels of a first end and a second end of the first inductor are pulled to a same voltage level when the transceiver operates in the receiving mode.

At least one embodiment of the present invention provides a method for controlling a configuration of a transceiver. The method may comprise: utilizing a first inductor of a transformer to couple the transformer to a power amplifier of the transceiver; utilizing a second inductor of the transformer to couple the transformer to a receiver of the transceiver; and utilizing at least one switch to control whether to pull voltage levels of a first end and a second end of the first inductor to a same voltage level according to whether the transceiver operates in the receiving mode or the transmitting mode.

The transceiver and the method provided by the embodiments of the present invention can configure output terminals of the power amplifier as short-circuit when the transceiver operates in the receiving mode, to make the receiver operate without being impacted by the power amplifier or less impacted by the power amplifier. In addition, the embodiments of the present invention will not greatly increase overall costs. Thus, the problem of the related art can be solved without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a transceiver according to an embodiment of the present invention.

FIG. 2 is a diagram illustrating some details of the transceiver shown in FIG. 1 according to an embodiment of the present invention.

FIG. 3 is a diagram illustrating some details of the transceiver shown in FIG. 1 that is operating in a transmitting mode according to an embodiment of the present invention.

FIG. 4 is a diagram illustrating some details of the transceiver shown in FIG. 1 that is operating in a receiving mode according to an embodiment of the present invention.

FIG. 5 is a diagram illustrating a working flow of a method for controlling a configuration of a transceiver according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

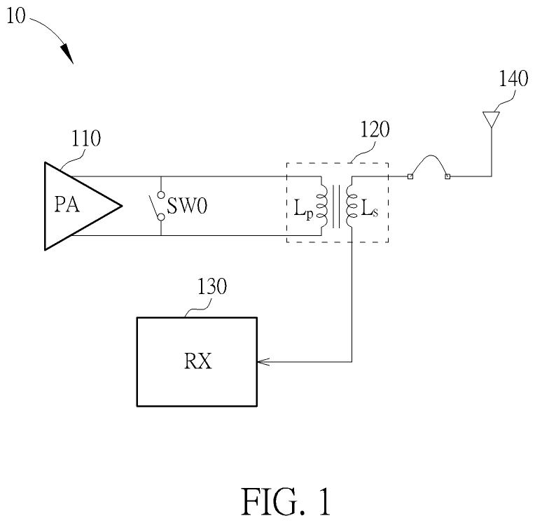

FIG. 1 is a diagram illustrating a transceiver 10 according to an embodiment of the present invention. As shown in FIG. 1, the transceiver 10 may comprise a power amplifier 110 (labeled “PA” in figures for brevity), a transformer 120, a receiver 130 (labeled “RX” in figures for brevity) and an antenna 140. The transformer 120 may comprise a first inductor such as an inductor L_{P} and a second inductor such as an inductor L_{S}, where the inductor L_{P} is coupled to the power amplifier 110, and the inductor L_{S} is coupled to the receiver 130. For example, a first end and a second end of the inductor L_{P} are respectively coupled to output terminals of the power amplifier, and a first end and a second end of the inductor L_{S} are respectively coupled to the antenna 140 and the receiver 130. When the transceiver 10 operates in a transmitting mode, the power amplifier 110 is configured to output transmitted signals (e.g., a pair of differential transmitted signals). For example, the power amplifier 110 may output the differential transmitted signals to the transformer 120, and the transformer may convert the differential transmitted signals into a single-ended transmitted signal, to make the antenna 140 send the single-ended transmitted signal, but the present invention is not limited thereto. When the transceiver 10 operates in a receiving mode, the receiver 130 is configured to receive a received signal (e.g., a single-ended received signal). For example, the antenna 140 may receive the single-ended received signal from the air, and the receiver 130 may receive the single-ended received signal from the antenna 140 via the inductor L_{S}, but the present invention is not limited thereto. More particularly, at least one switch may be configured to control whether to pull voltage levels of the first end and the second end of the inductor L_{P} to a same voltage level according to whether the transceiver 10 operates in the receiving mode or the transmitting mode. More particularly, the voltage levels of the first end and the second end of the inductor L_{P} may be pulled to the same voltage level when the transceiver 10 operates in the receiving mode. It should be noted that a control switch SW0 illustrated in FIG. 1 is for illustrative purposes only, and is not meant to be a limitation of the present invention. As long as the first end and the second end of the inductor L_{P} can be substantially shorted in response to the transceiver 10 operating in the receiving mode, implementation of connection control between the first end and the second end of the inductor L_{P} is not limited to utilizing the control switch SW0.

If the connection control between the first end and the second end of the inductor L_{P} is disabled (e.g., the control switch SW0 is always turned off), the impedance introduced by the power amplifier 110 and the transformer 120 will be hard to be controlled. For example, Z_{L} may represent the impedance introduced by the power amplifier 110, k may represent a K-factor of the transformer 120 (e.g., a mutual inductance M between the inductors L_{P} and L_{S} may be k·\sqrt{L_{P}L_{S}}), s may represent a frequency parameter, and an input impedance Zᵢₙ of the transformer 120 for the receiving mode (e.g., an input impedance regarding a right side of the transformer 120 in FIG. 1) may be expressed as follows:

$${Z}_{in} = ( s {L}_{s} ( 1 - {k}^{2} ) + \frac{s {L}_{s}}{s {L}_{p}} \cdot {Z}_{L} ) \cdot \frac{s {L}_{p}}{s {L}_{p} + {Z}_{L}}$$

Assuming that the power amplifier 110 comprises a capacitor load C_{L} on the output terminals thereof when the power amplifier 110 is turned off or disabled (e.g., Z_{L}=1/sC_{L}) in a situation where the transceiver 10 operates in the receiving mode, the input impedance Zᵢₙ of the transformer 120 may be expressed as follows:

$${Z}_{in} = ( s {L}_{s} ( 1 - {k}^{2} ) + \frac{s {L}_{s}}{s {L}_{p}} \cdot \frac{1}{{sC}_{L}} ) \cdot \frac{s {L}_{p}}{s {L}_{p} + \frac{1}{{sC}_{L}}}$$

Thus, when the frequency of the received signal is less than a resonant frequency

$$( e . g . , \frac{1}{2 π \sqrt{{L}_{P} {C}_{L}}} )$$

of the power amplifier 110, the input impedance Zᵢₙ may be inductive; when the frequency of the received signal is higher than the resonant frequency, the input impedance Zᵢₙ may be capacitive; and when the frequency of the received signal hits the resonant frequency, the input impedance Zᵢₙ may be a high impedance (e.g., a local maximum impedance). Thus, the input impedance Zᵢₙ may vary in response to different frequencies of the received signal, and thereby impact the operation of the receiving mode (e.g., impacting an overall input impedance of the receiver 130), which makes the optimization of the receiver mode be challenging.

In order to minimize the impact introduced by the power amplifier 110 and the transformer 120 in a situation where the transceiver 10 operates in the receiving mode, the first end and the second end of the inductor L_{P} can be shorted, which makes the impedance introduced by the power amplifier 110 be zero (e.g., Z_{L}=0), thereby minimizing the overall impedance introduced by the power amplifier 110 and the transformer 120 for the receiving mode. For example, the input impedance Zᵢₙ under a condition where the first end and the second end of the inductor L_{P} are shorted may be expressed as follows:

$${Z}_{in} = ( s {L}_{s} ( 1 - {k}^{2} ) + \frac{s {L}_{s}}{s {L}_{p}} \cdot 0 ) \cdot \frac{s {L}_{p}}{s {L}_{p} + 0} = {sL}_{s} ( 1 - {k}^{2} )$$

Thus, the input impedance Zᵢₙ is determined by k and L_{S} only, and is therefore much easier to be controlled in comparison with the previous case.

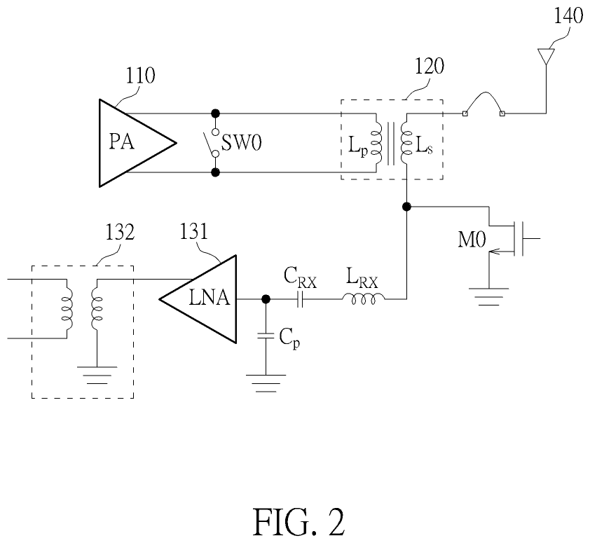

FIG. 2 is a diagram illustrating some details of the transceiver 10 shown in FIG. 1 according to an embodiment of the present invention. The receiver 130 may comprise an inductor L_{RX}, a capacitor C_{RX}, a low noise amplifier 131 (labeled “LNA” in figures for brevity) and a transformer 132 as shown in FIG. 2, where C_{P} may represent a parasitic capacitor of an input terminal of the low noise amplifier 131. Detailed operations of the inductor L_{RX}, the capacitor C_{RX}, the low noise amplifier 131 and the transformer 132 within the receiver 130 should be well known by those skilled in this art, and are therefore omitted here for brevity. When the transceiver 10 operates in the transmitting mode, an input impedance of the receiver 130, which is determined by L_{RX}, C_{RX} and C_{P}, may impact the operation of the transmitting mode. In order to prevent the transmitting mode from being impacted by the input impedance of the receiver 130 or minimize the impact of the input impedance of the receiver 130, the transceiver 10 may further comprise a control switch such as a transistor M0, wherein the transistor M0 is coupled between the second end of the inductor L_{S} and a reference voltage terminal (e.g., a ground voltage terminal), wherein the control switch is controlled (e.g., by controlling a voltage level of a gate terminal of the transistor M0) according to whether the transceiver 10 operates in the receiving mode or the transmitting mode. When the transceiver 10 operates in the receiving mode, the control switch is turned off (e.g., a turn-off voltage corresponding to a logic value “0” may be applied to the gate terminal of the transistor M0). When the transceiver operates in the transmitting mode, the control switch is turned on (e.g., a turn-on voltage corresponding to a logic value “1” may be applied to the gate terminal of the transistor M0), in order to pull a voltage level of the second end of the inductor L_{S} to a reference voltage level (e.g., a ground voltage level), which makes the input impedance of the receiver 130 be zero, thereby preventing the receiver from impacting operations of the transmitting mode.

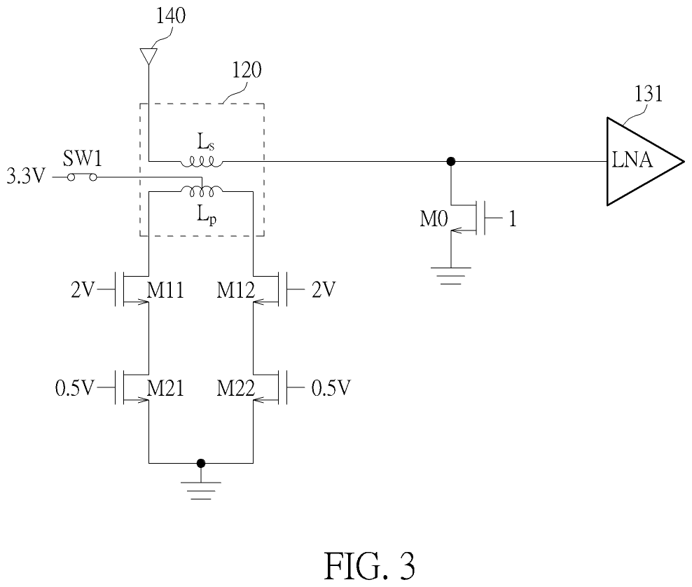

FIG. 3 is a diagram illustrating some details of the transceiver 10 shown in FIG. 1 that is operating in the transmitting mode according to an embodiment of the present invention, where the inductor L_{RX}, the capacitor C_{RX}, and the transformer 132 within the receiver 130 are not shown in FIG. 3 for brevity. In this embodiment, the power amplifier 110 may comprise transistors M11, M12, M21 and M22, where the transistor M11 is coupled to the first end of the inductor L_{P}, the transistor M12 is coupled to the second end of the first inductor L_{P}, the transistor M21 is coupled between the transistor M11 and a reference voltage terminal (e.g., a ground voltage terminal), and the transistor M22 is coupled between the transistor M12 and the reference voltage terminal. In addition, the transceiver 10 may further comprise a control switch SW1, where the control switch SW1 is coupled between a center tap of the inductor L_{P} and a supply voltage terminal, and the control switch SW1 is controlled according to whether the transceiver operates in the transmitting mode or the receiving mode. When the transceiver 10 operates in the transmitting mode, the control switch SW1 is turned on, in order to pull a voltage level of center tap of the inductor L_{P} to a supply voltage level such as 3.3 volts (V), and the transistor M0 is turned on (e.g., by applying the turn-on voltage corresponding to the logic value “1” to the gate terminal of the transistor M0), in order to eliminate the impact of the input impedance of the receiver 130, where gate terminals of the transistors M11 and M12 are biased at 2 V, and gate terminals of the transistors M21 and M22 are biased at 0.5 V, in order to perform power amplification on signals on the gate terminals of the transistors M21 and M22. Under this bias condition, the signals on the gate terminals of the transistors M21 and M22 are amplified to generate the transmitted signals on the first end and the second end of the inductor L_{P}.

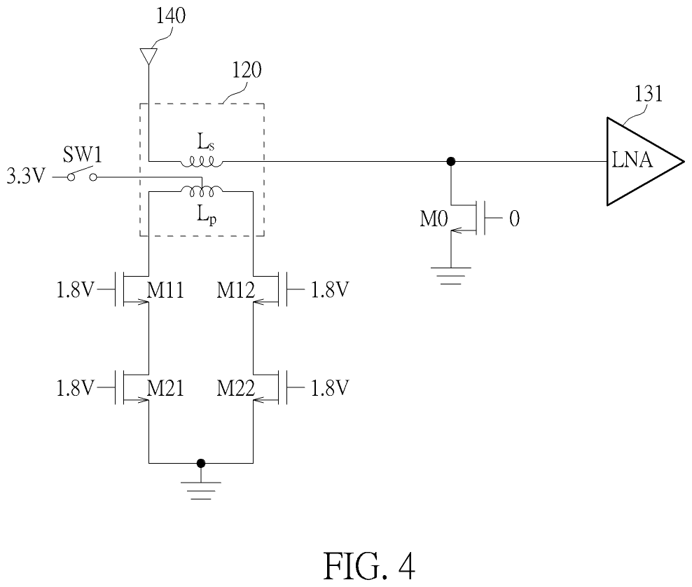

When the transceiver 10 operates in the receiving mode as shown in FIG. 4, the control switch SW1 is turned off, and the transistor M0 is turned off (e.g., by applying the turn-off voltage corresponding to the logic value “0” to the gate terminal of the transistor M0), where the gate terminals of the transistors M11, M12, M21 and M22 are biased at 1.8 V, in order to make all of the transistors M11, M12, M21 and M22 act as turned-on switches. Under this bias condition, the voltage level of the first end of the inductor L_{P} are pulled to a voltage level of the reference voltage terminal (e.g., 0 V) via the transistors M11 and M21, and the voltage level of the second end of the inductor L_{P} are pulled to the voltage level of the reference voltage terminal (e.g., 0V) via the transistors M12 and M22. Thus, the first end and the second end of the inductor L_{P} are substantially shorted, which can prevent the input impedance of the power amplifier from impacting the operations of the receiving mode. In addition, as the control switch SW1 is turned off, there is no direct current flowing from the supply voltage terminal to the reference voltage terminal. Thus, the embodiments of the present invention will not greatly increase additional power consumption, and the problem of compromising performance of any one of the transmitting mode and the receiving mode can be solved.

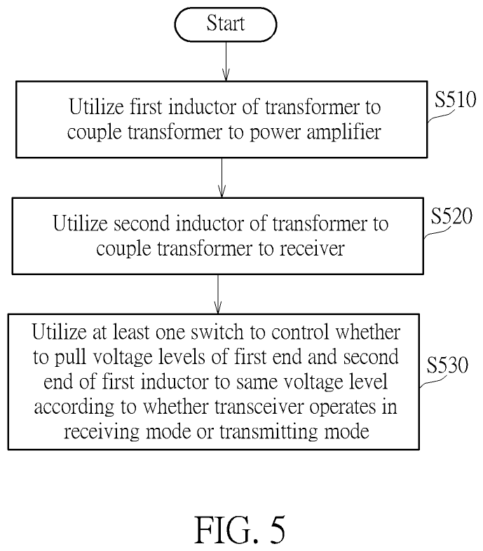

FIG. 5 is a diagram illustrating a working flow of a method for controlling a configuration of a transceiver (e.g., the transceiver 10 shown in FIG. 1) according to an embodiment of the present invention. It should be noted that the working flow shown in FIG. 5 is for illustrative purposes only, and is not meant to be a limitation of the present invention. One or more steps may be added, deleted or modified in the working flow shown in FIG. 5 if a same result can be obtained. In addition, these steps do not have to be executed in the exact order shown in FIG. 5.

In Step S510, the transceiver may utilize a first inductor of a transformer (e.g., the inductor L_{P} of the transformer 120 shown in FIG. 1) to couple the transformer to a power amplifier (e.g., the power amplifier 110 shown in FIG. 1) of the transceiver.

In Step S520, the transceiver may utilize a second inductor of the transformer (e.g., the inductor L_{S} of the transformer 120 shown in FIG. 1) to couple the transformer to a receiver (e.g., the receiver 130 shown in FIG. 1) of the transceiver.

In Step S530, the transceiver may utilize at least one switch (e.g., the control switch SW0 shown in FIG. 1 or the transistors M11, M12, M21 and M22 shown in FIGS. 3 and 4) to control whether to pull voltage levels of a first end and a second end of the first inductor to a same voltage level according to whether the transceiver operates in the receiving mode or the transmitting mode.

To summarize, the transceiver and the method provided by the embodiments of the present invention can short the output terminals of the power amplifier (or two ends of the inductor which is coupled to the power amplifier) to prevent an impedance of a transmitting path from impacting performance of a receiving path in a transceiver. Thus, the performance of the transmitting path and the performance of the receiving path can be optimized independently without compromising any one of them. In addition, the embodiments of the present invention will not greatly increase overall costs. Thus, the present invention can solve the problem of the related art without introducing any side effect or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transceiver, comprising:
a power amplifier, configured to output transmitted signals when the transceiver operates in a transmitting mode;
a receiver, configured to receive a received signal when the transceiver operates in a receiving mode; and
a transformer, comprising:
a first inductor, coupled to the power amplifier; and
a second inductor, coupled to the receiver;
wherein voltage levels of a first end and a second end of the first inductor are pulled to a same voltage level when the transceiver operates in the receiving mode.

2. The transceiver of claim 1, wherein a first end of the second inductor is coupled to an antenna, and a second end of the second inductor is coupled to the receiver.

3. The transceiver of claim 2, further comprising:
a control switch, coupled between the second end of the second inductor and a reference voltage terminal, wherein the control switch is controlled according to whether the transceiver operates in the transmitting mode or the receiving mode.

4. The transceiver of claim 3, wherein the control switch is turned off when the transceiver operates in the receiving mode; and the control switch is turned on when the transceiver operates in the transmitting mode, in order to pull a voltage level of the second end of the second inductor to a reference voltage level.

5. The transceiver of claim 1, wherein the power amplifier comprises:
a first transistor, coupled to the first end of the first inductor;
a second transistor, coupled to the second end of the first inductor;
a third transistor, coupled between the first transistor and a reference voltage terminal; and
a fourth transistor, coupled between the second transistor and the reference voltage terminal.

6. The transceiver of claim 5, wherein when the transceiver operates in the transmitting mode, signals on gate terminals of the third transistor and the fourth transistor are amplified to generate the transmitted signals on the first end and the second end of the first inductor.

7. The transceiver of claim 5, wherein when the transceiver operates in the receiving mode, the voltage level of the first end of the first inductor is pulled to a voltage level of the reference voltage terminal via the first transistor and the third transistor, and the voltage level of the second end of the first inductor is pulled to the voltage level of the reference voltage terminal via the second transistor and the fourth transistor.

8. The transceiver of claim 5, further comprising:
a control switch, coupled between a center tap of the first inductor and a supply voltage terminal, wherein the control switch is controlled according to whether the transceiver operates in the transmitting mode or the receiving mode.

9. The transceiver of claim 8, wherein the control switch is turned off when the transceiver operates in the receiving mode; and the control switch is turned on when the transceiver operates in the transmitting mode, in order to pull a voltage level of center tap of the first inductor to a supply voltage level of the supply voltage terminal.

10. A method for controlling a configuration of a transceiver, comprising:
utilizing a first inductor of a transformer to couple the transformer to a power amplifier of the transceiver;
utilizing a second inductor of the transformer to couple the transformer to a receiver of the transceiver; and
utilizing at least one switch to control whether to pull voltage levels of a first end and a second end of the first inductor to a same voltage level according to whether the transceiver operates in the receiving mode or the transmitting mode.

11. The method of claim 10, wherein a first end of the second inductor is coupled to an antenna, and a second end of the second inductor is coupled to the receiver.

12. The method of claim 11, further comprising:
utilizing a control switch to control connection between the second end of the second inductor and a reference voltage terminal according to whether the transceiver operates in the transmitting mode or the receiving mode.

13. The method of claim 12, wherein the control switch is turned off when the transceiver operates in the receiving mode; and the control switch is turned on when the transceiver operates in the transmitting mode, in order to pull a voltage level of the second end of the second inductor to a reference voltage level.

14. The method of claim 10, wherein the power amplifier comprises:
a first transistor, coupled to the first end of the first inductor;
a second transistor, coupled to the second end of the first inductor;
a third transistor, coupled between the first transistor and a reference voltage terminal; and
a fourth transistor, coupled between the second transistor and the reference voltage terminal.

15. The method of claim 14, wherein in response to the transceiver operating in the transmitting mode, signals on gate terminals of the third transistor and the fourth transistor are amplified to generate transmitted signals on the first end and the second end of the first inductor.

16. The method of claim 14, wherein in response to the transceiver operating in the receiving mode, the voltage level of the first end of the first inductor is pulled to a voltage level of the reference voltage terminal via the first transistor and the third transistor, and the voltage level of the second end of the first inductor is pulled to the voltage level of the reference voltage terminal via the second transistor and the fourth transistor.

17. The method of claim 14, further comprising:
utilizing a control switch to control connection between a center tap of the first inductor and a supply voltage terminal according to whether the transceiver operates in the transmitting mode or the receiving mode.

18. The method of claim 17, wherein the control switch is turned off when the transceiver operates in the receiving mode; and the control switch is turned on when the transceiver operates in the transmitting mode, in order to pull a voltage level of center tap of the first inductor to a supply voltage level of the supply voltage terminal.
